(19) United States
(12) Patent Application Publication
(10) Pub. No.: US 2023/0032864 A1
(43) Pub. Date: Feb. 2, 2023

(54) ARRANGEMENT FOR A PASSAGE SYSTEM AND METHOD FOR OPERATING AN ARRANGEMENT

(71) Applicant: WANZL GMBH & CO. KGAA, Leipheim (DE)

(72) Inventors: Juergen HAEMMERLE, Guenzburg (DE); Tiberius SOLTES, Guenzburg (DE); Joerg BAUMEISTER, Krumbach (DE); Dirk WEBERT, Leipheim (DE)

(21) Appl. No.: 17/758,568

(22) PCT Filed: Jan. 7, 2021
(86) PCT No.: PCT/EP2021/050197

§ 371 Date: Jul. 8, 2022

(30) Foreign Application Priority Data
Jan. 9, 2020 (DE) 20 2020 100 094.2

(51) Int. Cl. E06B 11/08; G01V 8/22

(52) U.S. Cl. CPC E06B 11/085; G01V 8/22

(57) ABSTRACT

An arrangement for a passage system comprising at least one door post and a barrier device, said arrangement comprising at least one post and horizontal bars, wherein a plurality of transmitting and receiving units are provided on a first bar and wherein, furthermore, a plurality of reflector strips are located on an opposite second bar.

### TECHNICAL FIELD

The present invention relates to an improved arrangement for a passage system, in particular for a passage system having improved swing region monitoring of a pedestrian passage. The invention furthermore describes a method for operating such an arrangement.

### BACKGROUND AND SUMMARY

Such an arrangement for a passage system is known from European patent specification 0 075 806 B1. This is a swing door arrangement for passage systems having a contactless pedestrian scanning device for actuating an electromotive swing door drive, in which the mounting of the door leaf, its driveshaft having a pivot gear, and a rotational direction-reversing electric motor are arranged within an upright tubular housing anchored on the floor. The swing door arrangement provides a barrier releasing at a specific torque, which is arranged between a part connected to the door leaf and a part connected to the housing. The mounting of the door leaf, its driveshaft having the pivot drive, and the electric motor are arranged as a columnar structural unit on both sides of a flange plate, which is guided in the fixed housing connected to the floor and is screwed onto flange attachments. A tube, which encloses the structural unit, is connected to the door leaf, contains the barrier, and the diameter of which corresponds to that of the housing, can be placed axially over the structural unit protruding beyond the housing with guiding on the driveshaft. The mounting of the door leaf can be screwed to a housing cap, which terminates the housing column on top, via an inside flange connection.

The passage system consists of two opposing swing doors, the door leaves of which are arranged in the closed state on a common vertical plane. A contactless pedestrian scanning device in the form of a light barrier is connected to the swing doors. If a person steps through the light beam of the light barrier, the door leaves open in the passage direction and close automatically after passage of a specific time.

Furthermore, a so-called “panic bolt” is used, which permits the door leaves to be opened with application of a specific force opposite to the passage direction in the case of panic.

In one post, a transceiver unit, in particular an emitting diode, is arranged, which interacts with a reflector located in the opposite post. The posts are fixedly connected to the door posts via bars. The door posts have a housing fixedly anchored on the ground, and a tube rotatably mounted thereon, on which the door leaves are fastened.

In the cited prior art, the light barrier is arranged in a first post. An opening is provided in the tubular post, through which the light beam generated by an emitting diode arranged in the interior of the first post passes.

A reflector is arranged on a second, opposing post, which reflects a part of the light emitted by the transceiver unit.

The light beam emitted by the transceiver unit is conical and forms a substantially larger area in the region of the reflector than the mirror surface of the reflector. In the normal case, the reflector is located in the emitted light cone. The light cone also detects during the passage of a transport cart, for example, a shopping cart, through the passage formed by the tubular posts, wherein shading takes place on the reflector. This shading causes the triggering of an electrical pulse in the transceiver unit for the purpose of automatically opening the door leaves. As also described in EP 0 622 514 B1, the door leaves open and typically pivot out by 90°. After a predetermined time span, both pivot back again into their starting location, in which the passage is closed.

The conical light beam is generated by an emitting diode at a light exit angle of approximately 10 to 15 degrees. A photodiode or a phototransistor is provided as the light receiver. The emitting diode and the photodiode or the phototransistor together essentially form the transceiver unit.

A strongly reflective plastic film is provided as the reflector. A dimension of 16×100 mm is used with a tubular post of 60 mm.

The distance between both tubular posts is typically 1000 mm. The diameter of the light cone at a distance of 700 mm from the light source is already at least 120 mm in size here.

In a refining development, for example, as described in EP 0 643 189 A1, the transceiver unit is provided in the entry region on a lower bar, which forms the connection between the post and the door post. In particular, the bar is arranged on the housing.

A system of the present type is also disclosed in DE 10 2012 106 404 B4, which is equipped with swing region monitoring. The energy consumption of the system can be reduced by a reduced power in the idle and open position of the barrier device, i.e., the door leaf. The respectively required braking power is queried on the basis of an angle measuring system and provided variably.

Furthermore, such transceiver units and corresponding reflectors are used in so-called swing region monitoring. Such monitoring is also disclosed in EP 0 643 189 A1, which is already cited. In this case, a door leaf is prevented from hitting a person still located in the passage. After passage of the keeping open time, the swing doors close automatically, presuming that the sensors arranged in the entry direction after the door leaf recognize that a person is no longer located in the swing region of the door leaf. A plurality of transceiver units is arranged on a lower horizontal bar for this purpose. A corresponding number of reflectors is located on an opposing horizontal bar at the same height.

However, the reflectors may be damaged, or the position of the reflectors cannot be permanently ensured, since the bar on which the reflectors are predominantly arranged moves or has slipped or shifted in its mounting.

Furthermore, it can be the case that the horizontal bar in which the transceiver unit is arranged was also moved or pivoted in its mounting, so that the light beam no longer strikes the opposing reflectors.

It is therefore an object of the present invention to provide an improved arrangement for a passage system, in which the use of the reflectors is permanently ensured.

According to the present invention, this object is achieved by an arrangement for a passage system having at least one first door post and having a barrier device, having at least one first post and having horizontal bars, wherein a plurality of transceiver units is provided on a first bar and wherein furthermore a plurality of reflector strips is arranged on an opposing second bar.

It is therefore a concept of the present invention to enlarge the reflector surface and thus achieve better utilization of the light barrier and compensate for possible misalignments of the horizontal bars.

The barrier device can preferably be embodied in the form of a swing door. This embodiment is cost-effective and is typically used in supermarkets. Such a system can be embodied with one or else two swing doors.

The number of transceiver units and reflector strips can preferably be dependent on the embodiment of the barrier device. In a swing door, the length of the swing arm of the swing door is dimensioned depending on the width of the passage. Upon opening of the passage, the swing arm remains in a space-saving manner and pivots by approximately 90° between two horizontal bars. Depending on the width of the passage and number of the swing doors, the number of transceiver units and of reflector strips is to be provided accordingly.

The arrangement preferably provides, in addition to the first horizontal bar and the second opposing horizontal bar, a further opposing second horizontal bar, which is arranged below the opposing second bar.

In this embodiment of the arrangement, there is the possibility of using the distance between these two bars, so that preferably both second bars can be provided for accommodating a plurality of reflector strips.

In a further embodiment of the arrangement, it is conceivable that only the second bar is provided for accommodating a plurality of reflector strips.

In one preferred embodiment, a distance can be provided between the two reflector strips. The distance between two reflector strips can preferably be 50 and 100 mm, preferably 80 mm. The use of reflector strips can be saved in this way, by which costs may be saved.

Furthermore, it can prove to be advantageous if the width of a reflector strip is in a range from 10 to 70 mm, preferably 40 mm. Furthermore, the height of a reflector strip can be in a range from 180 to 320 mm, preferably 260 mm. The reflector strips may be processed easily in these sizes.

In a refining embodiment, the height of a reflector strip can be embodied in such a way that the reflector strips touch the ground. The lower second bar is omitted accordingly and can therefore be saved.

It has proven to be reasonable if the reflector strips are formed from a reflector film. This can be purchased in a commercially available manner and may be processed easily.

Furthermore, it is expedient to also ensure a permanent use of adhesively bonding the reflector strips on a wall.

Depending on the type of the embodiment, the bars are embodied differently, so that various numbers of transceiver units are to be installed. Advantageously, a number of one to ten reflector strips is used per transceiver unit.

Furthermore, it proves to be reasonable if a distance of 100 to 150 mm is provided between the individual transceiver units.

Depending on the size of the system, a distance of 0.5 and 2.5 m, preferably 1 and 2 m, between the transceiver units and the reflector strips is conceivable.

Furthermore, the object can be achieved by a method for operating the arrangement, by providing an advanced obstacle detection (AOD) area. For this purpose, a division into a zone region 1 and 2 is performed, wherein in the zone regions 1 and 2, a movement of a person or of an object can also be detected at a low speed, wherein the barrier device 5 immediately stops and wherein furthermore the barrier device 5 can be moved with a low force in the desired direction.

### BRIEF DESCRIPTION OF THE FIGURES

Exemplary embodiments of the invention are illustrated in the drawing and are explained in more detail in the following description. In the figures:

FIG. 1 shows a perspective illustration of an exemplary embodiment of the arrangement having two swing doors and a possible light beam course,

FIG. 2 shows a further perspective illustration of the example shown in FIG. 1,

FIG. 3 shows a further perspective illustration of the example shown in FIG. 1 with a view of the transceiver units installed in the horizontal bar,

FIG. 4 shows a further perspective illustration of the example shown in FIG. 1 having two open swing doors,

FIG. 5 shows a perspective illustration of a further embodiment of an arrangement which is equipped with reflector strips that lead to the ground, and

FIG. 6 shows a perspective illustration of a further embodiment of an arrangement in which two lower second bars are provided on each side.

FIGS. 7 to 15 show various operating states.

### DETAILED DESCRIPTION

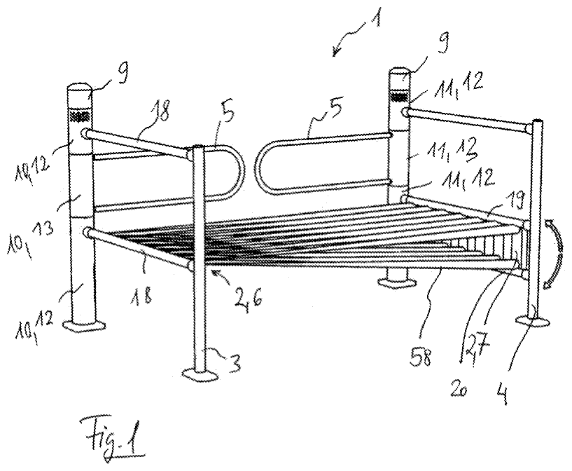

An exemplary embodiment of the arrangement 1 according to the invention of a passage system is shown in FIG. 1. It has two posts 3, 4, which are embodied as tubular posts. In the present embodiment, a first post 3 and a second post 4 are shown, each of which has a barrier device 5 in a rotatably mounted tube 13. In the present case, a swing door is used. This is formed from two curved door leaves.

Further embodiments of door leaves or swing doors are conceivable. For example, only one door leaf may be sufficient. Furthermore, another type of a barrier device, for example, a turnstile, alternatively sliding doors, or other types of revolving doors, can be used.

In FIG. 1, two door posts 10, 11, namely a first door post 10 and a second door post 11, are shown. These have a housing 12 which is divided by a rotatably mounted tube 13 on which the barrier device 5 is arranged. The housing 12 furthermore provides a housing cap 9. A drive, as described in the prior art, is integrated in the interior of the housing 12. Horizontal bars 18, 19, 20 are arranged on the housing parts 12. The bars 18, 19, 20 each merge into one post 3, 4. A first post 3 and a second post 4 are used in the present case.

The arrangement 1 has a light barrier 2. This is used for monitoring the swing region of the barrier device 5. If the light barrier 2 is interrupted, for example, if a person or a transport cart remains in this region, the barrier device 5 is in an open state so that the passage can be passed through.

As can be seen from FIG. 1, an upper and a lower bar 18 are arranged between the first door post 10 and the first post 3. A transceiver unit 6 of a light barrier 2 is provided in the lower bar 18. On the opposite side, the reflectors 7 of the light barrier 2 are provided, which are embodied in the form of reflector strips 7. In particular, the reflector strips 7 are arranged in the region between a second bar 19 and a further lower second bar 20. It has proven to be reasonable to first provide a planar receptacle between both bars 19, 20. The reflector strips 7 can then be applied thereon, preferably adhesively bonded. The outside of the planar receptacle can additionally be used to attach advertising or other notifications.

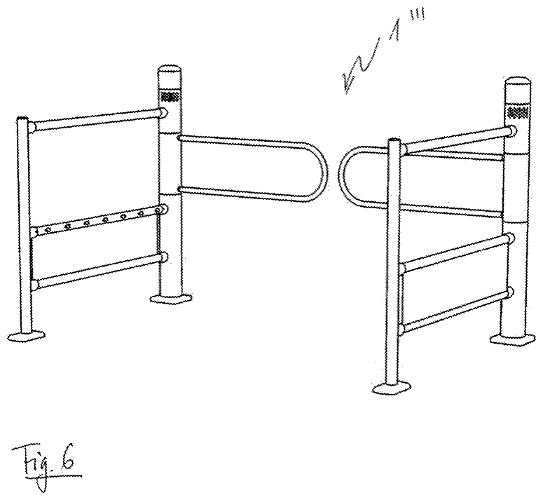

In the refining embodiment of an arrangement 1′″, as shown in FIG. 6, such a planar receptacle is provided on both sides.

The light beam 58 is emitted by the transceiver unit 6 and is incident on one of the reflector strips 7, which are arranged opposite. These reflect the light beam 58 and it can be received again by the transceiver unit 6.

After passing through the passage, the barrier device 5 only closes again when the light beam 58 is no longer interrupted by the person or the object.

Due to the large area of the reflectors 7, which are preferably embodied from vertical strips, the error tolerance is increased multiple times.

A distance is preferably provided between the individual reflector strips 7. This distance does not have a reflective material. A transparent material can also be used here, for example. The error-free recognition may furthermore be significantly improved in this way.

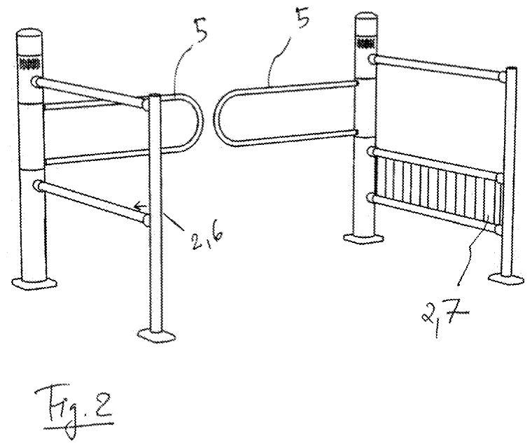

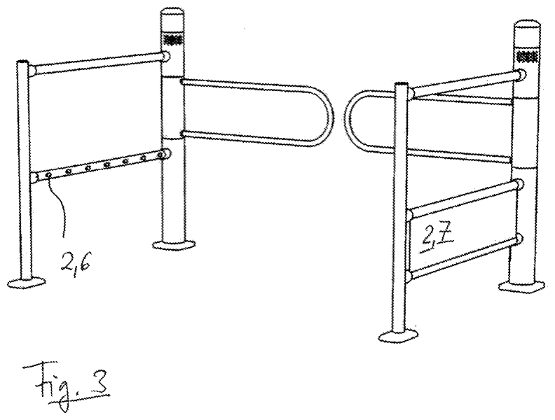

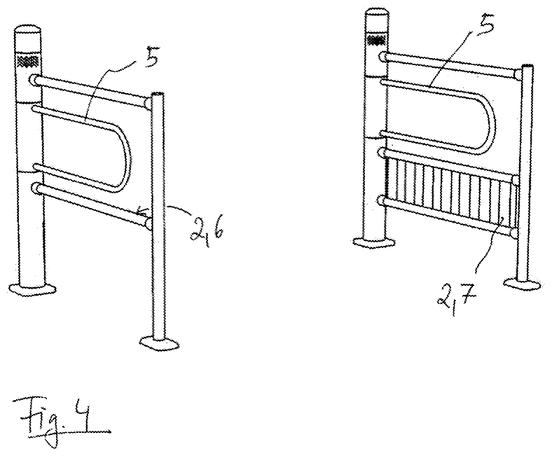

FIG. 2 shows the arrangement 1 from the same perspective, wherein no light beams are shown. FIG. 3 shows the arrangement 1 once again from another perspective, namely looking toward the transceiver unit. An open arrangement 1 of the passage system is shown in FIG. 4.

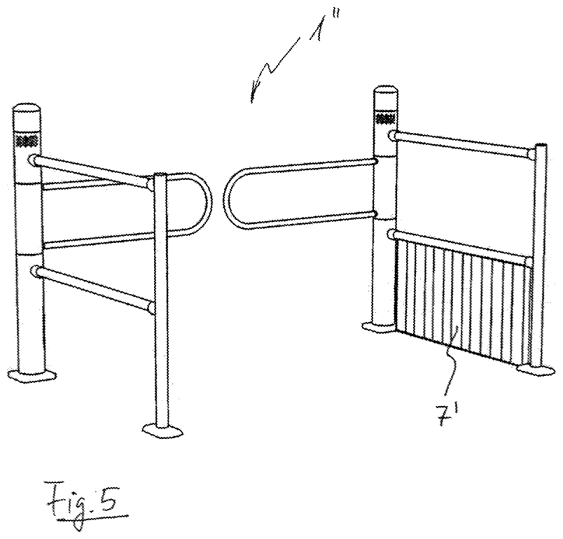

FIG. 5 shows a refining embodiment. In arrangement 1″, the reflector strips 7′ are embodied down to the ground. A planar receptacle can also be provided in this embodiment. This is then also embodied down to the ground. The lower second bar 20 can be omitted.

In a refining exemplary embodiment, as illustrated in the following pages, a division of the arrangement 1, 1′, 1″ into an entry region R1 and a monitoring region R2 is provided. The entry region R1 is located in front of the door posts 10, 11 and the monitoring region, radar region R2, behind the door posts 10, 11, in particular in the region in which the bars 18, 19 are provided. The monitoring region, radar region R2, can also be embodied outside the arrangement 1, 1′, 1″.

Radar region R1 detects in the direction of the entry region. R2 detects in the direction of the loading side. Furthermore, a division into the zone 1 and 2 takes place in the region of the arrangement 1, 1″, 1′″.

In the exemplary description following, various operating states 1 to 7 are described in more detail.

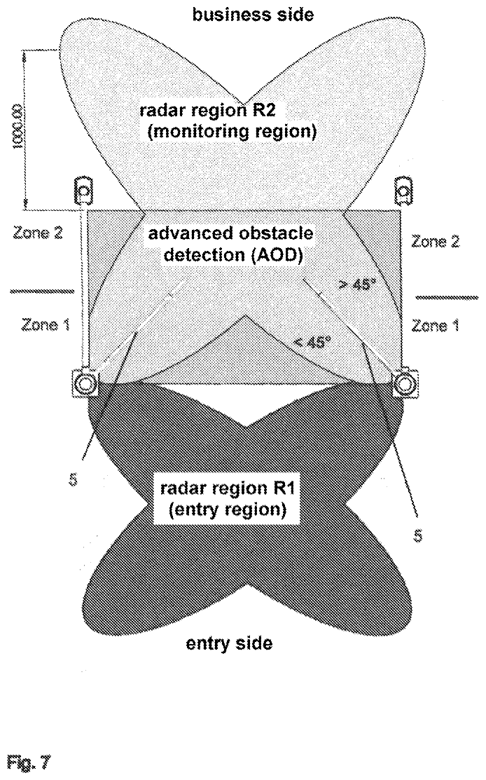

In FIG. 7 et seq., the expansion of the radar detection region is described.

### Plan

The backwards radar normally used to activate an audible alarm is used for an expanded detection region. This enables the control of the movements of the swing arms by scanning the movement before a customer reaches the AOD zone 2.

### Goal

This expanded detection region detects movements at a minimum speed of 0.3 m/s to at most 1 meter beyond the AOD. If an object is detected, the swing arm stops moving and the arms can be pushed or pulled by the customers with little force (5 pounds).

### Remarks

If R1 triggers an opening and closing cycle, the swing arms remain open for tₒₚₑₙ=8 s.

If R2 detects movements longer than tₐₗₐᵣₘ=1 s or the customer enters the AOD, an audible alarm sounds until the customer has left R2 or the AOD.

R2 consists of 2 separate radars (left and right) and each radar controls the respective passage arm independently.

0° means that the passages are closed and 90° means completely open arms.

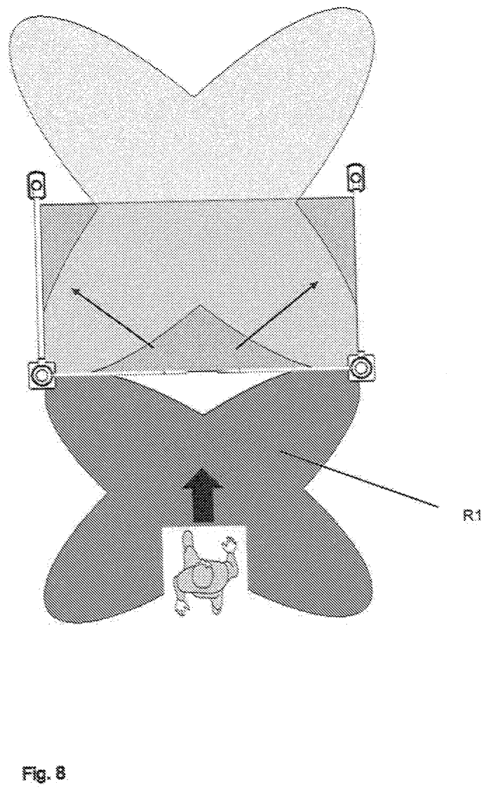

FIG. 8 shows an expansion of the radar detection region CASE 1

Swing arm starting status:

closed

Customer entry side:

customer detected by R1

Customer business side:

not present

Result:

swing arms begin to open and close after tₒₚₑₙ.

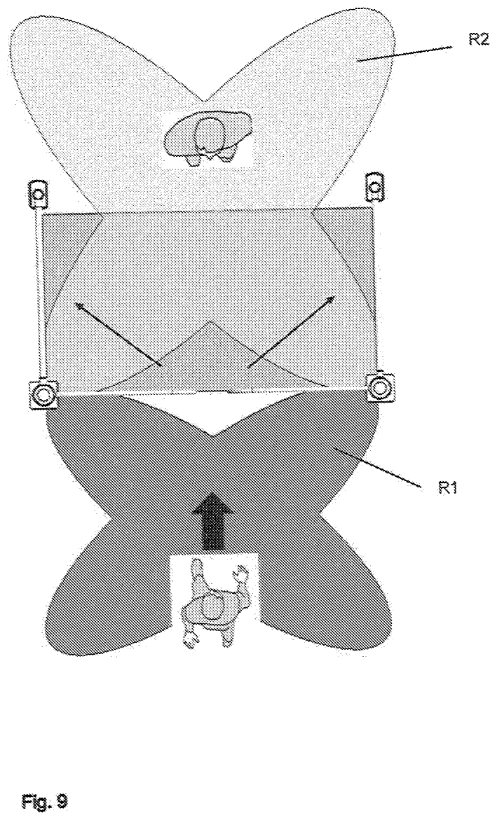

FIG. 9 shows an expansion of the radar detection region CASE 2

Swing arm starting status:

closed

Customer entry side:

customer detected by R1

Customer business side:

customer detected by R2

Result:

swing arms open

acoustic alarm for incorrect direction after tₐₗₐᵣₘ or after customer enters AOD.

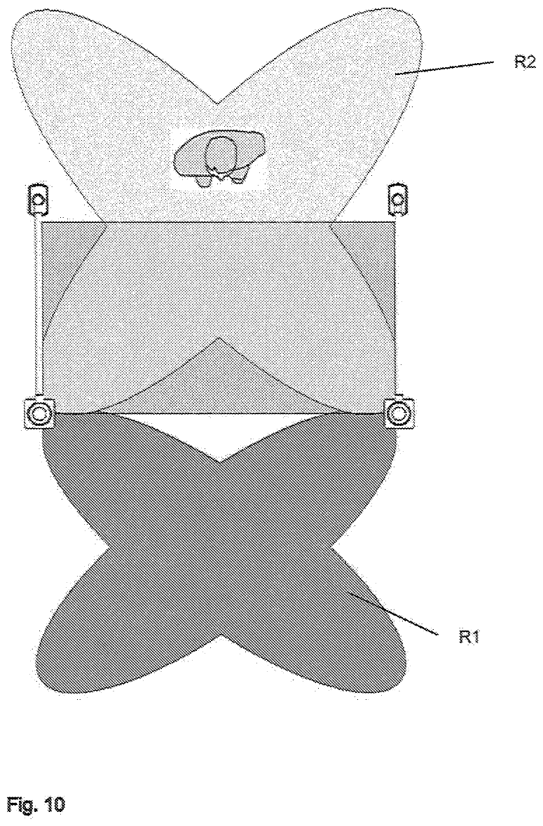

FIG. 10 shows an expansion of the radar detection region CASE 3

Swing arm starting status:

open

Customer entry side:

customer detected by R1 or already in business

Customer business side:

customer detected by R2

Result:

swing arms remain open for tₒₚₑₙ, which has started again after R2 has detected the customer, and remain open as long as the customer is detected by R2

audible alarm for incorrect direction after tₐₗₐᵣₘ or after customer enters AOD.

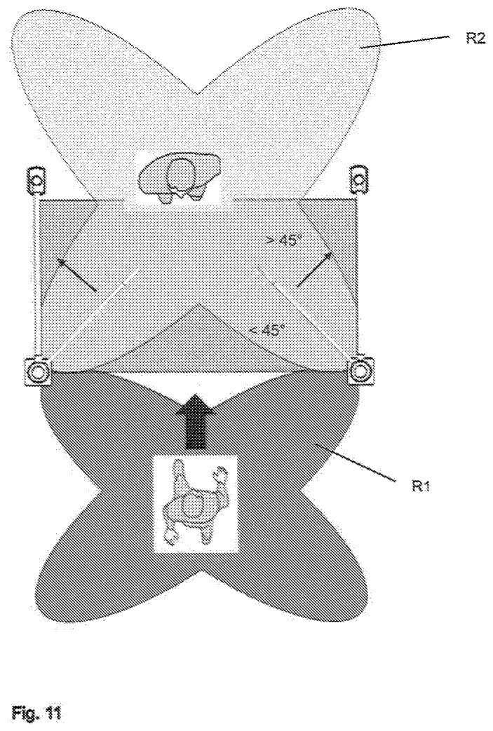

FIG. 11 shows an expansion of the radar detection region CASE 4

Swing arm starting status:

opening movement

Customer entry side:

customer detected by R1

Customer business side:

customer detected by R2 and immediately thereafter by AOD (zone 2)

Result:

swing arms open further until the zone 2 detects the customer from the business side, and thereupon the arms stop in the present position

audible alarm for incorrect direction after tₐₗₐᵣₘ or after customer enters AOD.

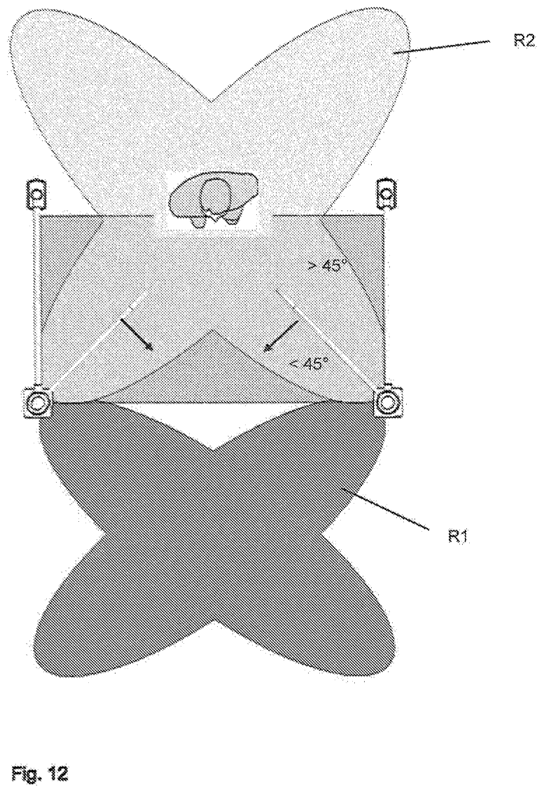

FIG. 12 shows an expansion of the radar detection region CASE 5

Swing arm starting status:

closing movement

Customer entry side:

not present

Customer business side:

customer detected by R2 and immediately thereafter by AOD (zone 2)

Result:

swing arms close further if the opening angle is <45° (zone 1) and stop if the opening angle is >45° (zone 2)

position is maintained as long as person is detected by AOD—audible alarm for incorrect direction after tₐₗₐᵣₘ or after customer enters AOD.

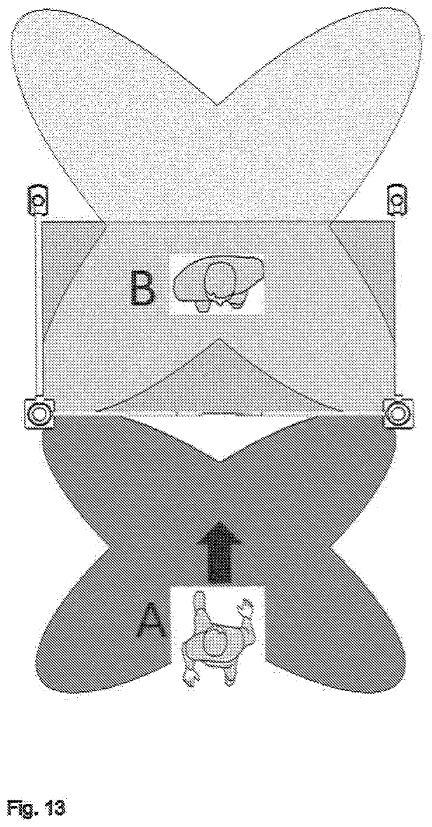

FIG. 13 shows an expansion of the radar detection region CASE 6

Swing arm starting status:

closed, open, or in movement

Customer entry side:

customer detected by R1

Customer business side:

customer detected by AOD

Result:

swing arms stop and continue movement after customer has left the AOD

audible alarm for incorrect direction after tₐₗₐᵣₘ or after customer enters AOD.

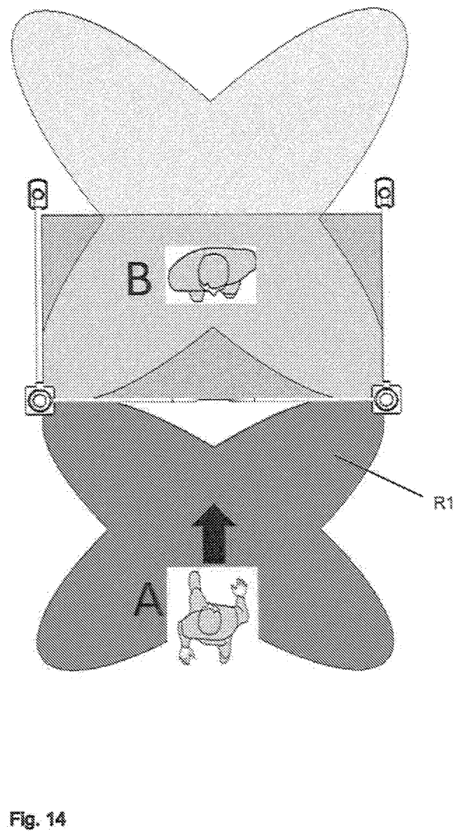

FIG. 14 also shows an expansion of the radar detection region CASE 6

Swing arm starting status:

closed, open

Customer entry side:

customer detected by R1

Customer business side:

customer detected by AOD

Result:

swing arms stop and continue movement after customer has left the AOD

audible alarm for incorrect direction after tₐₗₐᵣₘ or after customer enters AOD.

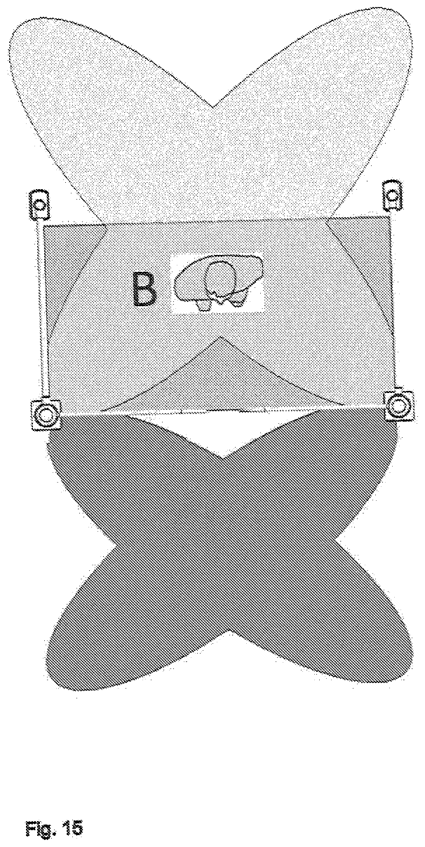

FIG. 15 shows an expansion of the radar detection region CASE 7

Swing arm starting status:

closed

Customer entry side:

not present

Customer business side:

customer detected by AOD

Result:

swing arms remain in the stopped position and do not open further after customer has left the AOD

audible alarm for incorrect direction after tₐₗₐᵣₘ or after customer enters AOD.

### LIST OF REFERENCE SIGNS

1, 1″, 1′″ arrangement
2 light barrier
3 first post
4 second post
5 barrier device
6 transceiver unit
7, 7″ reflector strips, reflectors
9 housing cap
10 first door post
11 second door post
12 housing
13 rotatably mounted tube
18 first bar
19 second bar
20 lower second bar
58 light beam
R1 entry region
R2 monitoring region
AOD advanced obstacle detection

1. An arrangement for a passage system comprising:
at least one door post;
a barrier device;
at least one post; and
a plurality of horizontal bars connecting the at least one door post and the at least one post, wherein a plurality of transceiver units are provided on a first bar of the plurality of horizontal bars and wherein a plurality of reflector strips are arranged on an opposing second bar of the plurality of horizontal bars, wherein the opposing second bar is connecting a second door post of the at least one door post and a second post of the at least one post.

2. The arrangement as claimed in claim 1, wherein the barrier device is a swing door.

3. The arrangement as claimed in claim 1, wherein the number of transceiver units and reflector strips is dependent on the embodiment of the barrier device.

4. The arrangement as claimed in claim 1, wherein a further opposing third bar of the plurality of horizontal bars is provided, which is arranged below the opposing second bar of the plurality of horizontal bars.

5. The arrangement as claimed in claim 4, wherein a second plurality of reflector slips are arranged on the third bar of the plurality of horizontal bars.

6. The arrangement as claimed in claim 1, wherein only the second bar is provided to accommodate the plurality of reflector strips.

7. The arrangement as claimed in claim 1, wherein a distance is provided between each reflector strip of the plurality of reflector strips.

8. The arrangement as claimed in claim 7, wherein the distance between each reflector strip of the plurality of reflector strips is between 50 and 100 mm.

9. The arrangement as claimed in claim 1, wherein the width of a reflector strip of the plurality of reflector strips is in a range from 10 to 70 mm.

10. The arrangement as claimed in claim 1, wherein the height of a reflector strip of the plurality of reflector strips is in a range from 180 to 320 mm.

11. The arrangement as claimed in claim 1, wherein the height of a reflector strip of the plurality of reflector strips is embodied in such a way that each of the reflector strips of the plurality of reflector strips touches the ground.

12. The arrangement as claimed in claim 1, wherein the plurality of reflector strips are each formed from a reflector film.

13. The arrangement as claimed in claim 1, wherein the plurality of reflector strips are each adhesively bonded on a wall.

14. The arrangement as claimed in claim 1, wherein one to ten reflector strips of the plurality of reflector strips is used per transceiver unit of the plurality of transceiver units.

15. The arrangement as claimed in claim 1, wherein a distance between two transceiver units of the plurality of transceiver units is 100 to 150 mm.

16. The arrangement as claimed in claim 1, wherein a distance of 0.5 and 2.5 m is provided between a transceiver unit of the plurality of transceiver units and a reflector strip of the plurality of reflector strips.

17. A method for operating the arrangement as claimed in claim 1 using an advanced obstacle detection, comprising:
dividing a radar detection area into zone 1 and 2,
detecting movement of a person or an object at low speed in zone 1 and 2,
wherein a barrier immediately stops upon detection of the person or the object in zone 1 and 2; and wherein the barrier device moves with a low force in a desired direction.
